(19) United States
(12) Patent Application Publication
(10) Pub. No.: US 2008/0204692 A1
(43) Pub. Date: Aug. 28, 2008

(54) MICROLITHOGRAPHIC PROJECTION EXPOSURE APPARATUS AND METHOD FOR PRODUCING MICROSTRUCTURED COMPONENTS

(75) Inventors: Toralf Gruner, Aalen-Hofen (DE); Bernd Geh, Scottsdale, AZ (US)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/054,991

(22) Filed: Mar. 25, 2008

Related U.S. Application Data
(63) Continuation of application No. PCT/IB06/03878, filed on Nov. 8, 2006.

(30) Foreign Application Priority Data
Nov. 10, 2005 (DE) 10 2005 053 651.4

(51) Int. Cl. G03B 27/72; G03B 27/54

(52) U.S. Cl. 355/71; 355/67

(57) ABSTRACT

A method for producing microstructured components in a microlithographic projection exposure apparatus is disclosed. The method includes imaging a pattern of structures into an image plane of a projection objective. The dose distribution of projection light in the image plane can be influenced so that the image of a structure is at least essentially independent of the topography of structures which lie inside a region surrounding the structure.

### CROSS-REFERENCE TO RELATED APPLICATIONS

This application is a continuation application and claims benefit of International Patent Application Serial No. PCT/IB2006/003878, filed on Nov. 8, 2006, which claims benefit of German patent application 10 2005 053 651.4, filed Nov. 10, 2005. International Patent Application Serial No. PCT/IB2006/003878 is incorporated herein in its entirety.

### FIELD

The disclosure relates to microlithographic projection exposure apparatus, such as those used for the production of large-scale integrated electrical circuits and other microstructured components. The disclosure relates in particular to measures making it possible to image identical structures with equal widths.

### BACKGROUND

Integrated electrical circuits and other microstructured components are conventionally produced by applying a plurality of structured layers onto a suitable substrate which, for example, may be a silicon wafer. In order to structure the layers, they are first covered with a photoresist which is sensitive to light of a particular wavelength range, for example light in the deep ultraviolet (DUV) spectral range. The wafer coated in this way is subsequently exposed in a projection exposure apparatus. A pattern of diffracting structures, which lies on a mask, is thereby imaged onto the photoresist with the aid of a projection objective. Since the imaging scale is generally less than 1, such projection objectives are also often referred to as reduction objectives.

After the photoresist has been developed, the wafer is subjected to an etching process so that the layer becomes structured according to the pattern on the mask. The photoresist still remaining is then removed from the remaining parts of the layer. This process is repeated until all the layers have been applied on the wafer.

For unimpaired function of the microstructured components produced in this way, it is often desirable that structures with identical dimensions be imaged with the same width on the photo resist irrespective of their orientation and their position on the mask. CDU (critical dimensioning uniformity) is often employed as a measure of the uniformity with which identical structures are imaged while being distributed over the field.

The photoresists generally used nowadays have the property that they have a relatively sharp exposure threshold. This means that a point on the photoresist is fully exposed when the radiation energy incident thereon in the course of the entire exposure process exceeds a particular value. If this radiation energy lies below this value, then the point remains unexposed. The width of a structure therefore can depend on the region on the photoresist over which the exposure threshold is exceeded. The radiation energy incident on a surface element is generally referred to in photometry as irradiation. In microlithography and in the present application however, the term radiation dose, or dose for short, is used for this quantity. The unit of the radiation dose is joule per square millimetre (J/mm²).

In order to prevent identical structures from being imaged with a different width depending on position and orientation on the mask, devices have been developed with which the radiation dose can be deliberately adjusted field-dependently.

### SUMMARY

In some embodiments, the disclosure provides a method with which undesired structure width variations can be reduced.

In certain embodiments, the disclosure provides a method for producing microstructured components using a microlithographic projection exposure apparatus, in which a pattern of structures is imaged into an image plane of a projection objective. The dose distribution of projection light in the image plane is influenced so that the image of a structure is at least essentially independent of the topography of structures which lie inside a region surrounding the structure.

The term “topography of the structures” in the present context is intended to cover all factors which affect the intensity of the light transmitted by the structures. These include particularly the size and thickness of the structures; when polarized light is used, the orientation of the structures also has such an effect.

The disclosure is based, at least in part, on the discovery that the measurable radiation dose at a point in the image plane depends not only on the duration of the exposure, influenceable inter alia by adjustable diaphragm elements, and on the polarization state of the incident light, but also on the topography of the structures which surround the point. The cause of this effect is believed to be that when bright structures are being imaged, a part of the projection light coming from the structures is lost by scattering. If a bright structure in the pattern has a dark surrounding, then a part of its intensity will be scattered into this dark surrounding. This reduces the light intensity at the image position of the structure. If on the other hand the surrounding of the structure is bright, then although intensity at the image position is likewise lost by scattering, an even larger amount of light from the bright surrounding is nevertheless scattered to the image position. In this way, the intensity at the image position is increased the brighter the surrounding of the structure is.

The dose distribution can therefore be adjusted not only as a function of the specific properties of the illumination system and of the projection objective, but also as a function of the pattern of structures which is intended to be imaged into the image plane of the projection objective.

Since the scattering is not sharply delimited angle-dependently and therefore also—in terms of the image plane-position-dependently, the region surrounding the structure, whose brightness influences the intensity of the image of the structure, will in principle be imaged by the entire illuminated light field on the mask. The greatest exchange of scattered light from a structure into the surrounding and vice versa, however, takes place in a relatively small region. The influences on the dose distribution at the image position can therefore be approximately determined well by taking into account only the structure topography and therefore the brightness distribution of such a relatively small region with predetermined size and shape around the image position.

If position-independent scattering is assumed in the transparent optical materials of the projection objective, then in principle the effect of the topography of the surrounding structures on the scattered light distribution can be calculated. The question of how to predetermine the shape and particularly the size of the region, in which the topography of the structures is taken into account for the scattered light distribution, then depends essentially on the available computing power and computing time.

Often, however, it is the case that the scattering in the optical materials is not homogeneous, for example because the material at the edge of a lens is inferior to that in its middle. In this case, instead of a substantially exact calculation, it may be more favourable to carry out an approximation in which only the average brightness of the surrounding region is taken into account. This may, for example, be determined by integration over the entire surface of bright structures inside the region. With such an approximate solution, with a known topography of the structures, it is possible to determine very quickly whether the intensity on the image of a structure is increased by scattered light from surrounding bright regions or the intensity is reduced by scattering losses into dark regions.

In order to be able to influence the dose distribution in the image plane so that identical structures are imaged field-independently with the same structure width despite the influences of the scattering on the intensity distribution, in principle the same measures may be implemented as those already known in the prior art for improving the CDU.

In this context, it is possible in particular to deliberately change the polarization state of the projection light. As already mentioned, especially for projection objectives with a particularly high numerical aperture, it is possible to influence the intensity at the image position in this way. The polarization state of a ray bundle incident on an image point may for example be changed by manipulators arranged in the near field, which influence the polarization state position-dependently.

As an alternative or in addition to this, it is possible for manipulators which influence the polarization state angle-dependently to be arranged near the pupil.

For projection exposure apparatus in which the pattern is projected onto the image plane in scan operation, the dose distribution in the image plane may be influenced by adjusting at least one diaphragm element, which is arranged in or in the vicinity of a field plane.

The adjustment can be carried out by displacing at least one diaphragm element in the scan direction. The field plane may also lie in the projection objective in this case.

For patterns whose structure density varies exclusively along the scan direction, in principle it is also conceivable to change the scan rate during the scan process in order to influence the dose distribution.

The pattern will generally be a mask used in transmission or reflection, as is known per se in the prior art. The disclosure, however, is also usable for patterns which include an arrangement of light sources which can be driven independently of one another. The dose distribution in the image plane can in this case be influenced in a particularly straightforward way by individually changing the luminosity of the light sources.

For illumination systems whose light source includes a matricial arrangement of light-emitting elements, as described for instance in WO 2004/006021 A, the dose distribution may also be influenced by appropriate driving of the light-emitting elements.

Another possibility for influencing the dose distribution in the image plane is for a lens, in an illumination system illuminating the pattern, to be tilted so that a symmetry axis of the lens makes an angle with an optical axis of the illumination system. The lens can be a field lens in the near field of the illumination system, and particularly its last lens as seen in the light propagation direction. In the case of this lens, tilting has the greatest effect on the dose distribution but without significantly changing the illumination angle distribution in an undesired way.

Tilting the lens increases the dose in the image plane approximately linearly along one direction. If the tilt axis is set up suitably, then the effect achieved may for example be that the dose increases linearly over the width of an illumination slit generated on the pattern by the illumination system. If the lens is tilted by an electrically driveable actuator, for example, then the tilt angle may readily be changed in pauses between individual exposures.

Tilting of a lens to compensate for undesired dose variations may also be used advantageously in conjunction with other causes of such dose variations. When exposing sizeable wafers, for example, it is often observed that the dose increases from exposure to exposure along a particular direction. Such a dose variation can be compensated for well by tilting the lens. Additional measures, for example changing the pulse frequency of a laser used for light generation, may be implemented in order to change a constant proportion of the dose over the entire image field.

When establishing the measures for influencing the dose distribution, it is of course necessary to take into account not only the topography of the structures of the pattern, but also all other effects which influence the dose distribution in the field plane. These effects may be accounted for integrally by first setting a homogeneous intensity distribution in the field plane without a mask, as is known in the prior art. The effect caused by the topography of the pattern is then taken into account only additively.

For influencing the dose distribution, however, the different effects which vary the dose distribution may also be taken into account by simulation. For the scattered light distribution in the image plane, besides the topography of the structures of the pattern, there is also an effect due to the geometrical path length which a light ray travels through the different optical materials.

Besides the scattered light distribution, double reflections in the projection objective also cause inhomogeneities of the intensity in the image plane. A double reflection occurs when light reflected at an optical interface is reflected back again at another optical interface, so that it can reach the image field in the image plane. Such double reflections may be calculated exactly or taken into account only approximately, for example by assuming that the intensity decreases from the field centre to the field edge according to a particular function.

### BRIEF DESCRIPTION OF THE DRAWINGS

Other features and advantages of the disclosure will be found from the following description of the exemplary embodiments with reference to the drawings, in which:

FIG. 1 shows a simplified perspective representation of a projection exposure apparatus according to the disclosure;

FIG. 2 shows a simplified meridian section through an illumination system of the projection exposure apparatus shown in FIG. 1;

FIG. 3 shows a graph in which a one-dimensional dose distribution in the image plane is plotted for a periodic arrangement of structures;

FIG. 4 shows a graph in which the dependence of the structure width on the scattered light level is represented by way of example for two different surrounding brightnesses;

FIG. 5 shows a simplified plan view of a field diaphragm with adjustable diaphragm elements, by which the dose distribution in the image plane can be influenced.

### DETAILED DESCRIPTION

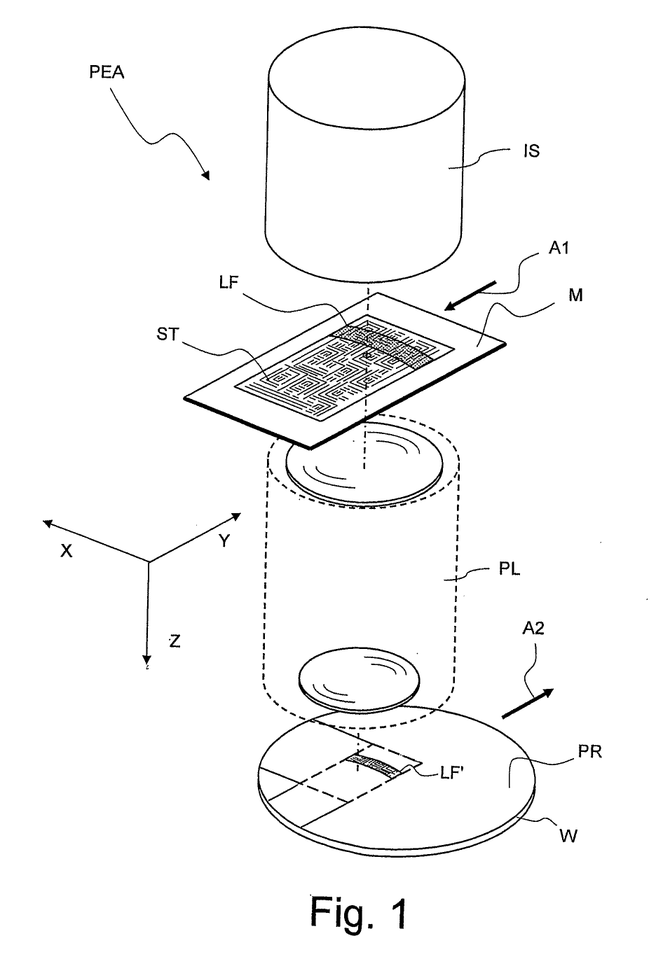

FIG. 1 shows a projection exposure apparatus PEA in a highly schematised representation which is not true to scale. The projection exposure apparatus PEA includes an illumination system IS for generating a projection light beam. On a mask M which contains transparent structures ST, this beam illuminates a narrow light field LF which is slightly curved in the exemplary embodiment represented. The transparent structures ST of the mask M which lie inside the light field LF are imaged onto a photoresist PR with the aid of a projection objective PL. The photoresist PR is a photosensitive layer which is applied onto a wafer W or another support, and which lies in the image plane of the projection objective PL. Since the projection objective PL generally has an imaging scale which is less than 1, a reduced image of the part of the mask M lying in the region of the light field LF is formed as a region LF′ on the photoresist PR.

In the exemplary embodiment represented, the mask M and the wafer W are displaced along a Y direction during the projection. The ratio of the displacement rates is equal to the imaging scale of the projection objective PL. If the projection objective PL generates inversion of the image, then the displacement movements of the mask M and the wafer W will be opposite as indicated by arrows A1 and A2 in FIG. 1. The light field LF is thereby guided over the mask M in a scan movement, so that even sizeable structured regions can be coherently projected onto photosensitive layer PR.

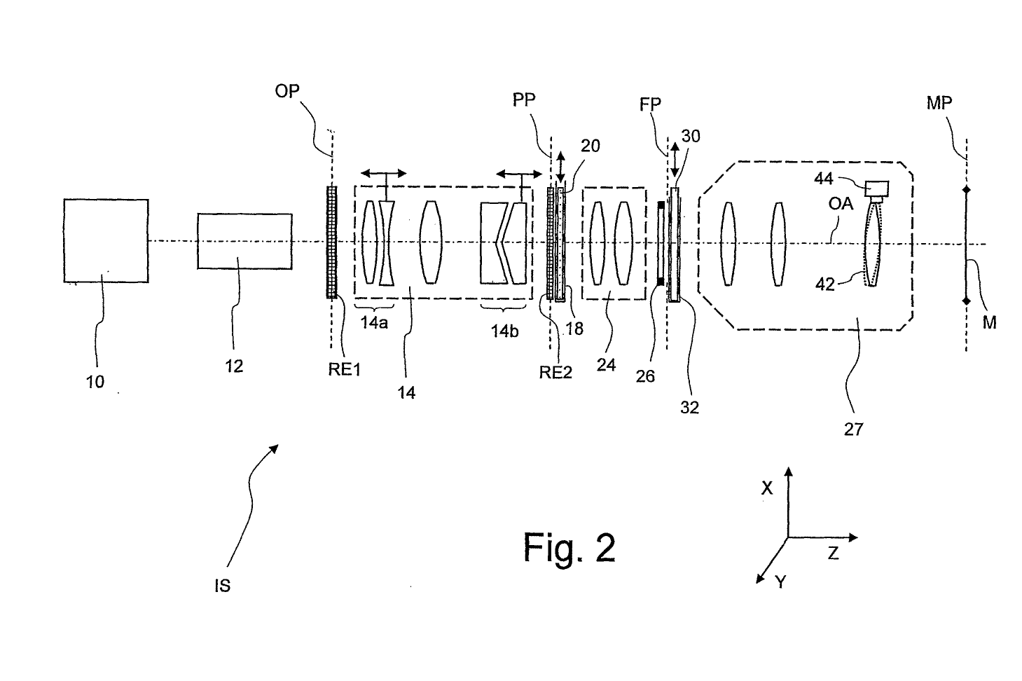

FIG. 2 shows the illumination system IS, indicated only schematically in FIG. 1, in a simplified meridian section which is not true to scale.

A light source 10, for example embodied as an excimer laser, generates monochromatic and highly collimated light with a wavelength in the ultraviolet spectral range, for example 193 nm or 157 nm. In a beam expander 12, which may for example be an adjustable mirror arrangement, the light generated by the light source 10 is expanded into a rectangular and substantially parallel ray bundle. The expanded ray bundle subsequently passes through a first optical grid element RE1 which, for example, may be a diffractive optical element. Other examples of suitable grid elements are described in the Applicant's U.S. Pat. No. 6,295,443, the disclosure of which is incorporated herein in its entirety. The purpose of the first optical grid element RE1 is to change the illumination angle distribution of the projection light and increase the geometrical optical flux.

The first optical grid element RE1 is arranged in an object plane OP of a beam shaping objective 14, by which the illumination angle distribution can be further modified and continuously changed. To this end the beam shaping objective 14 contains a zoom group 14a, which has at least one adjustable lens, and an axicon group 14b. The axicon group 14b includes two axicon elements with conical surfaces, the spacing of which is variable.

A second optical grid element RE2 is arranged in a pupil plane PP, which may be the exit pupil of the beam shaping objective 14. The purpose of the second optical grid element RE2 is to set the local intensity distribution in the mask plane MP, where the mask M is positioned with the aid of a positioning device (mask stage) not represented in detail. An exchange holder 18, which is intended to hold a polarizing pupil filter 20, is provided in the immediate vicinity of the pupil plane PP.

A condenser group 24, which transforms the pupil plane PP into a field plane FP, is arranged behind the second optical grid element RE2 in the light propagation direction. A field diaphragm 26, which sets the contour of the light field LF that illuminates the mask M, is arranged in the immediate vicinity of the field plane FP. The field diaphragm 26 is imaged onto the mask plane MP by a masking objective 27.

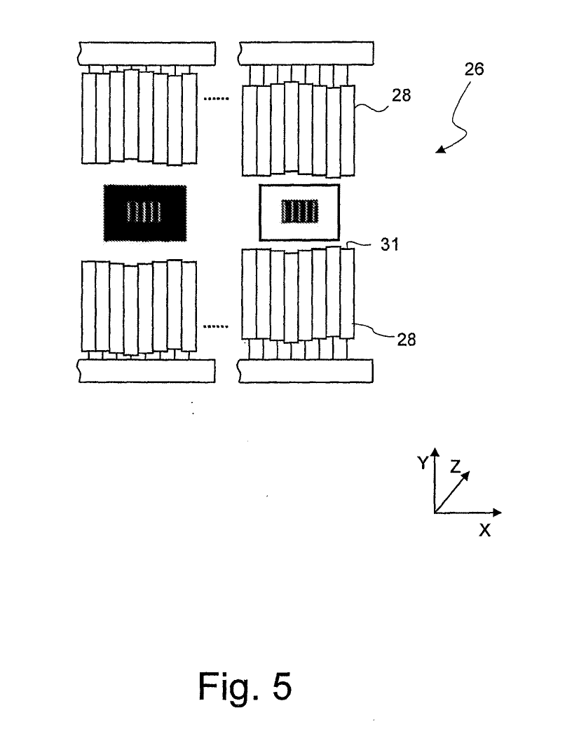

The field diaphragm 26, represented in a very simplified way here, includes a multiplicity of moveably arranged diaphragm elements 28 which can be seen only in the partial plan view of FIG. 5. The diaphragm elements 28 are configured as fingerlike rods which are subdivided into two mutually opposing groups. The diaphragm elements 28 can be displaced individually along the scan direction (Y direction). Drive units (not represented in detail) are used for this, as described for example in EP 1 020 769 A2. Further design details of the field diaphragm 26 are described in U.S. Pat. No. 6,404,499 B1.

The drive units for the diaphragm elements 28 are controlled so that respectively opposing diaphragm elements can be displaced synchronously in opposite directions. In this way, it is possible for free ends 31 of the diaphragm elements 28 to be displaced far enough into the projection light beam so that the longitudinal sides of the slit-shaped light field LF are thereby modified.

In the immediate vicinity of the field plane FP, there is a further exchange holder 32 into which a position-dependently polarizing polarizer 30 can be inserted if need be. The function of the polarizer 30 in conjunction with the pupil filter 20 will be explained in more detail below.

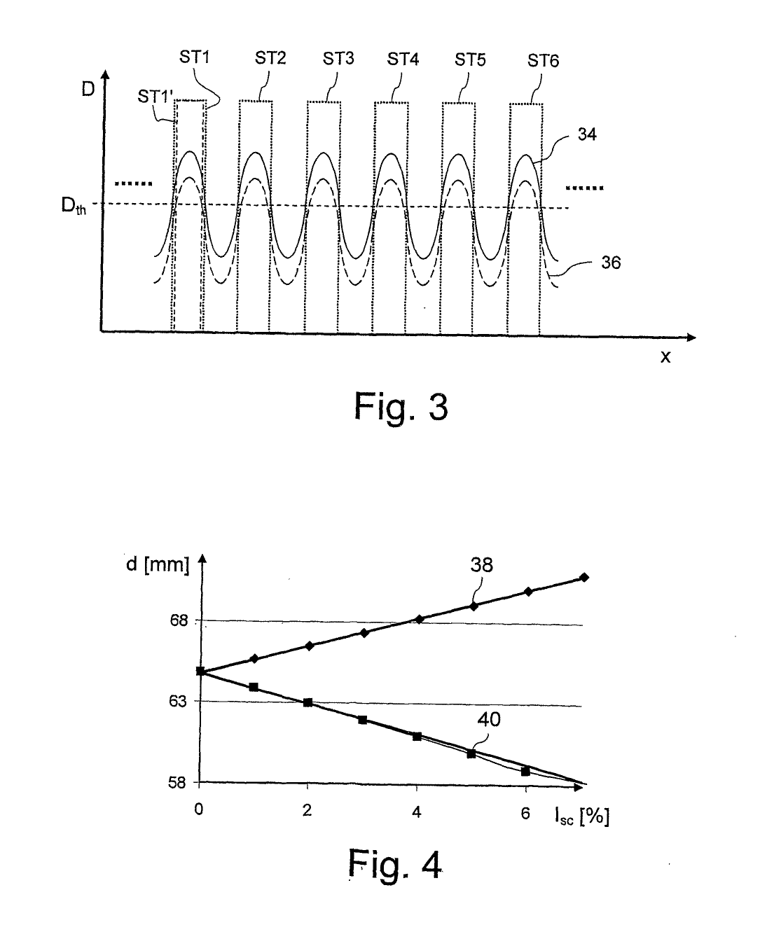

In FIG. 3, dotted lines show by way of example and partially a periodic arrangement of linear structures, which are denoted by ST1 to ST6. The structures ST1 to ST6 are imaged by the projection objective PL onto the photoresist PR. It is assumed that scattering, which may have different causes, occurs in the projection objective PL.

FIG. 3 furthermore represents by a solid line 34 the dose distribution D(x) as encountered in the case when the structures ST1 to ST6 have a bright surrounding. For comparison, a dashed line indicates the dose distribution D(x) for the case when the structures ST1 to ST6 have a dark surrounding. The exposure threshold, above which the photoresist PR is exposed, is denoted by Dₜₕ.

As can be seen in FIG. 3, the overall radiation dose D which arrives on a particular image point depends on how bright the surrounding of the conjugated object point on the mask M is. With a bright surrounding—compared to the case where no scattering occurs—the dose on the photoresist PR is increased because although light is lost by a scattering, light from the surrounding is nevertheless scattered onto the image positions of the structures ST1 to ST6 to an even greater extent. With a dark surrounding, on the other hand, the losses due to scattered light cannot be compensated for by scattering from a bright surrounding. The dose D of bright structures in a dark surrounding is consequently reduced, which in the absence of correction measures leads to a corresponding reduction of the structure widths. A structure ST1′, as would be generated on the photoresist PR by the structure ST1 in a dark surrounding, is indicated for illustration by dashed lines in FIG. 3.

The greater the scattering in the projection objective PL is, the greater is the effect explained above. Simulations show that the dependence of the structure width variation increases approximately linearly with the scattered light level I_{SC}. This linear relationship is shown with the aid of an example calculation in FIG. 4. Structure widths d are plotted in the graphs of FIG. 4 as a function of the scattered light level I_{SC}, indicated as a percentage, for the case of a bright structure in a bright surrounding (diamonds 38) and a bright structure in a dark surrounding (squares 40). Structure width variations of more than 7% already occur with a scattered light level of I_{SC}=6%, which can have a perturbing effect on the function of the microlithographically produced components.

In order to reduce these undesired structure width variations, the diaphragm elements 28 of the field diaphragm 26 are adjusted so as to compensate for the variations in the dose distribution on the photoresist PR, which result from the scattered light effect due to the surrounding of a structure to be imaged. The darker the surrounding of structures to be imaged is, the further apart from one another the diaphragm elements 28 are moved in order to let more light reach the relevant image positions during the scan process. This case is shown on the left-hand side in FIG. 5.

For structures with a bright surrounding as indicated on the right-hand side in FIG. 5, conversely, the diaphragm elements 28 are moved closer together so as to make the illuminated field LF on the mask M narrower, and thus reduce the dose on the photoresist PR.

If there are of relatively few bright structures on a mask and they are spaced relatively far apart from one another, then a larger distance can remain set between the diaphragm elements 28 throughout the scan process, as shown on the left in FIG. 5. The same applies in reverse for masks which include a large number of bright structures arranged very densely together over their entire surface. In this case as well, the arrangement of the diaphragm elements 28 can remain unchanged during the scan process, as shown on the right-hand side in FIG. 5.

For masks in which the density of the bright structures varies in the scan direction Y, however, it may be necessary to change the setting of the diaphragm elements 28 during the scan process in order to reduce structure width variations due to scattered light. In FIG. 5, this changeover between different settings of the diaphragm elements 28 is indicated by the dotted lines between the left and right halves of the figure.

In addition or as an alternative to adjusting the field diaphragm 26, the polarization state of the projection light may also be changed in order to influence the dose distribution on the photoresist PR. The pupil filter 20 may, for example, be a polarization-influencing optical element as is disclosed in US 2002/0176166 A1, the disclosure of which is incorporated herein in its entirety. When positioned in or close to a pupil plane, the polarization-influencing optical element described therein makes it possible to set a tangential or radial polarization. The case of tangential polarization corresponds to the s-polarization, in which the oscillation direction of the electric field vector extends perpendicularly to the incidence plane of the light. A tangential polarization is favourable particularly for projection objectives with a very high numerical aperture, since s-polarized light rays interfere with maximal contrast even when they converge at large angles of incidence onto a point in the image plane.

If the polarization state for a radial bundle converging onto a point in the image plane is changed so that light is not completely but only partially s-polarized, then although the light rays continue to interfere fully, the achievable contrast is nevertheless reduced. This is due to the fact that the z-components of the p-polarized residual component have opposite signs, which has a contrast-reducing effect. In general, however, there are polarizing optical elements in the beam path. If this is not the case, optical elements with a polarizing effect will be deliberately used. This offers the possibility of influencing the intensity and therefore also the radiation dose D in the image plane by deliberate changes of the polarization state.

In order to deliberately influence the polarization state of the ray bundle converging onto different field points, the position-dependently polarizing polarizer 30 is inserted into the exchange holder 32. The polarizer 30 may for example contain an arrangement of differently thick birefringent elements, as is also the case in the pupil filter 20 according to the aforementioned US 2002/0176166 A1. As an alternative to this, the polarizer 30 may contain gratings with different effective refractive indices for s- and p-polarized light, the refractive index difference varying over the surface of the polarizer 30 because of a differing design and arrangement of the grating structures.

So that the dose distribution on the photoresist PR can also be varied as a function of time, as may be necessary for example when changing the mask, it is possible for the polarizer 30 to be replaced by another polarizer with a different position-dependently polarization-influencing effect. As an alternative or in addition to this, the polarizer 30 in the exchange holder 32 may be rotated or shifted along the optical axis OA.

As an alternative or in addition to the polarizer 30 arranged in the near field, it is also possible to use an element arranged near the pupil which angle-dependently changes the polarizing state of projection light passing through. Such an element may for example contain intrinsically birefringent materials such as calcium fluoride (CaF₂). The thicker the material is at a particular position, the greater is the retardation experienced by orthogonal polarization states when passing through the material at a particular angle. The aforementioned grating structures with a different effective refractive index for s- and p-polarized light also often have an angle-dependent polarization effect, and can therefore be used for the same purpose in elements near the pupil.

Furthermore, there are a multiplicity of further possible ways in which the polarization state of the projection light can be changed field-dependently, so as to influence the dose distribution in the image plane. In this context reference is made to US 2005/0146704 (Gruner et al.), the contents of which is likewise incorporated herein in its entirety.

Another possibility for influencing the dose distribution in the image plane consists in tilting a lens of the illumination system IS. The lens lying closest to the mask plane MP is denoted by 42 in FIG. 2. The lens 42 is a field lens, which images a pupil plane lying in the mask objective 27 into the entry pupil of the projection objective 20. Owing to the near-field arrangement, tilting the lens 42 has a direct effect on the dose distribution in the image plane. In the exemplary embodiment represented, an actuator indicated by 44 in FIG. 2 is provided for tilting the lens 42.

What is claimed is:

1. A method, comprising:
using projection light to image a pattern of structures in a mask into an image plane of a projection objective of a microlithographic projection exposure apparatus,
wherein a dose distribution of the projection light in the image plane is influenced so that an image of a structure of the mask is at least essentially independent of the topography of structures of the mask which lie inside a region surrounding the structure of the mask.

2. The method according to claim 1, wherein the region surrounding the structure of the mask has a predetermined size and shape for all structures.

3. The method according to claim 1, further comprising taking into account an average brightness of the region surrounding the structure of the mask when influencing the dose distribution.

4. The method according to claim 3, wherein the average brightness is determined by integration over the entire surface of bright structures inside the region surrounding the structure of the mask.

5. The method according to claim 1, wherein the dose distribution in the image plane is influenced by changing a polarization state of the projection light.

6. The method according to claim 5, wherein the polarization state is changed position-dependently.

7. The method according to claim 5, wherein the polarization state is changed angle-dependently.

8. The method according to claim 1, wherein the pattern is projected into the image plane in a scan operation, and the dose distribution in the image plane is influenced by adjusting a diaphragm element which is arranged in or in the vicinity of a field plane.

9. The method according to claim 8, wherein the diaphragm element is displaced along a scan direction to influence the dose distribution.

10. The method according to claim 1, wherein the pattern is projected into the image plane in a scan operation, and the dose distribution in the image plane is influenced by changing a scan rate of the scan operation.

11. The method according to claim 1, wherein an arrangement of light sources is used, the light sources can be driven independently of one another, and the dose distribution in the image plane is influenced by individually changing the luminosity of the light sources.

12. The method according to claim 1, further comprising tilting a lens in an illumination system used to illuminate the pattern of structures in the mask so that a symmetry axis of the lens makes an angle with an optical axis of the illumination system.

13. The method according to claim 12, wherein a last lens of the illumination system, as seen in the light propagation direction, is tilted.

14. The method according to claim 1, wherein a scattered light distribution in the image plane is taken into account for influencing the dose distribution.

15. The method according to claim 1, wherein double reflections in the projection objective are taken into account for influencing the dose distribution.

16. The method according to claim 1, wherein the pattern of structures in the mask is projected into the image plane in a scan operation, and the dose distribution is influenced during the scan operation.

17. An apparatus, comprising:
a projection objective configured to use projection light to image a pattern of structures in a mask into an image plane of the projection objective; and
a manipulator configured to influence a dose distribution of the projection light in the image plane as a function of a topography of the structures in the mask,
wherein the apparatus is a microlithographic projection exposure apparatus.

18. The apparatus according to claim 17, wherein the manipulator is configured to influence the dose distribution of the projection light in the image plane so that an image of a structure in the mask is at least essentially independent of a topography of structures in the mask which lie inside a region surrounding the structure in the mask.

19. The apparatus according to claim 18, wherein the region surrounding the structure in the mask has a predetermined size and shape for all structures in the mask.

20. The apparatus according to claim 17, wherein the manipulator comprises a polarization-influencing element configured to change a polarization state of the projection light.

21. The apparatus according to claim 20, wherein the polarization-influencing element is configured to change the polarization state position-dependently.

22. The apparatus according to claim 20, wherein the polarization-influencing element is configured to change the polarization state angle-dependently.

23. The apparatus according to claim 17, wherein the manipulator comprises at least one adjustable diaphragm element arranged in or in the vicinity of a field plane.

24. The apparatus according to claim 23, wherein the at least one diaphragm element is displaceable along a scan direction of the projection objective.

25. The apparatus according to claim 17, wherein the manipulator is configured to influence a scan rate of the projection objective.

26. The apparatus according to claim 17, wherein the manipulator comprises an actuator configured to tilt a lens of an illumination system configured to illuminate the pattern of structures in the mask so that a symmetry axis of the lens makes an angle with an optical axis of the illumination system.

27. The apparatus according to claim 17, wherein an arrangement of light sources is used, the light sources can be driven independently of one another, and the manipulator is configured to influence the dose distribution in the image plane by individually changing the luminosity of the light sources.
